(19) United States
(12) Patent Application Publication
(10) Pub. No.: US 2013/0101193 A1
(43) Pub. Date: Apr. 25, 2013

(54) Positron Emission Tomography and Method for Correcting Attenuation of PET Image Using Magnetic Resonance Image

(71) Applicants: Jong Beom RA, Daejeon (KR); Woo Hyun Nam, Busan (KR); Kye Young Jeong, Busan (KR); Duhgoon Lee, Daejeon (KR); Ji Hye Kim, Anyang-si (KR)

(72) Inventors: Jong Beom RA, Daejeon (KR); Woo Hyun Nam, Busan (KR); Kye Young Jeong, Busan (KR); Duhgoon Lee, Daejeon (KR); Ji Hye Kim, Anyang-si (KR)

(21) Appl. No.: 13/277,952

(22) Filed: Oct. 20, 2011

(51) Int. Cl. G06K 9/00

(52) U.S. Cl. 382/131

(57) ABSTRACT

A positron emission tomography (PET) image attenuation correction method may be provided. The PET image attenuation correction method may include obtaining n three-dimensional (3D) magnetic resonance (MR) images and n 3D PET images classified based on a breathing state of an examined patient, generating attenuation correction maps with respect to the n 3D MR images using a single computed tomography (CT) image, obtained in advance, associated with the patient, correcting attenuation of the n 3D PET images based on the generated attenuation correction maps, and generating a single PET image by combining the n attenuation-corrected 3D PET images.

### TECHNICAL FIELD

The present invention relates to a positron emission tomography (PET) device and a method of correcting attenuation of a PET image using a magnetic resonance (MR) image, and more particularly, to a PET device and a method of correcting attenuation of a PET image using a single computer tomography (CT) image and n three-dimensional (3D) MR images.

### BACKGROUND ART

A positron emission tomography (PET)-computer tomography (CT) device may be a state-of-the-art image fusing device which combines a biochemical PET image that shows whether a problem exists in metabolic activity with an anatomical CT image that shows whether a structural error exists and thus, may determine a magnitude and a location of a lesion.

In general, a PET device may detect a significantly weak radiation ray and may generate an image. However, a strength of a radiation ray from an inside of a body and a strength of a radiation ray from a surface of the body may be different from each other and thus, the PET device may generate a PET image including noise and distortion. Accordingly, the PET image including noise and distortion may need to be corrected, which is referred to as PET attenuation correction. Conventionally, a CT image is used for the PET attenuation correction. In particular, the PET image may be obtained by photographing a patient over a period lasting for a maximum of dozens of minutes while the patient is breathing. Accordingly, an abdomen, a thorax, and the like may move due to the breathing of the patient. Conversely, the CT image may be photographed within one minute, and the breathing of the patient may not occur during the photographing.

When the CT image is used to perform the PET attenuation correction, there is a drawback in that the PET image including the movement of the patient does not accurately correspond to the CT image excluding the movement of the patient. To overcome the drawback, PET images and CT images may be classified based on a breathing state and may be reconfigured so as to obtain a 3D PET image and a 3D CT image, respectively. The PET attenuation correction may be performed using a corresponding PET image and a corresponding CT image of each breathing state. When the PET attenuation correction is performed as described in the foregoing, there exists a drawback in that a great amount of radiation ray may be irradiated to the patient since multiple CT images of patient need to be photographed.

### DISCLOSURE OF INVENTION

### Technical Goals

An aspect of the present invention also provides a positron emission tomography (PET) device and a PET image attenuation correcting method, which may perform attenuation correction with respect to a PET image using a single CT image and n 3D MR images classified based on a breathing state, which are high-definition images, so as to reduce an amount of radiation irradiated to an examined patient and to correct the movement associated with the breathing of the patient.

### Technical Solutions

According to an aspect of the present invention, there is provided a method of correcting attenuation of a positron emission tomography (PET) image, the method including obtaining n three-dimensional (3D) magnetic resonance (MR) images and n 3D PET images classified based on a breathing state of an examined patient, generating attenuation correction maps with respect to the n 3D MR images using a single computed tomography (CT) image, obtained in advance, associated with the patient, correcting attenuation of the n 3D PET images based on the generated attenuation correction maps, and generating a single PET image by combining the n attenuation-corrected 3D PET images.

According to another aspect of the present invention, there is provided a positron emission tomography (PET) device, the device including an image obtaining unit to classify magnetic resonance (MR) images and PET images based on a breathing state of an examined patient so as to obtain n three-dimensional (3D) MR images and n 3D PET images, an attenuation correction map generating unit to generate attenuation correction maps with respect to the n 3D MR images, using a single CT image, obtained in advance, associated with the patient, an attenuation correcting unit to correct attenuation of the n 3D PET images, using the generated attenuation correcting maps, and an image generating unit to generate a single PET image by combining the n attenuation-corrected 3D PET images.

### Effect

Embodiments of the present invention may provide a positron emission tomography (PET) device that performs PET attenuation correction using a single CT image and 3D MR images obtained based on a breathing state. Accordingly, the PET image attenuation correction may be performed based on the single CT image with respect to the patient and thus, may reduce an amount of radiation irradiated to the patient since multipleCT images of the patient may not need to be photographed.

Embodiments of the present invention may perform attenuation correction with respect to a PET image using a CT image and 3D MR images and thus, the movement associated with a breathing state of a patient may be accurately corrected.

### BRIEF DESCRIPTION OF DRAWINGS

FIG. 1 is a block diagram illustrating a configuration of a positron emission tomography (PET) device according to an embodiment of the present invention;

FIG. 2 is a flowchart illustrating a PET image attenuation correcting method according to an embodiment of the present invention;

FIG. 3 is a diagram illustrating an attenuation correction parameter computing method according to an embodiment of the present invention;

FIG. 4 is a diagram illustrating a method of generating an attenuation correction map with respect to a 3D MR image according to an embodiment of the present invention;

FIG. 5 is a transform function graph to be used for generating a computer tomography (CT) attenuation correction map with respect to a CT image according to an embodiment of the present invention; and

FIG. 6 is a diagram illustrating a PET image attenuation correcting method using an attenuation correction map according to an embodiment of the present invention.

### BEST MODE FOR CARRYING OUT THE INVENTION

Although a few embodiments of the present invention have been shown and described, the present invention is not limited to the described embodiments, wherein like reference numerals refer to the like elements throughout.

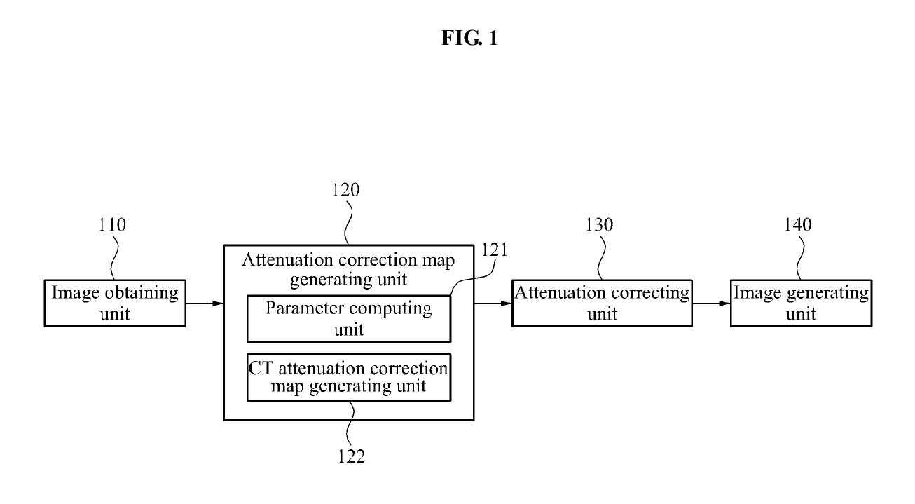

FIG. 1 illustrates a configuration of a positron emission tomography (PET) device according to an embodiment of the present invention. Referring to FIG. 1, the PET device may include an image obtaining unit 110, an attenuation correction map generating unit 120, an attenuation correcting unit 130, and an image generating unit 140.

The PET device of FIG. 1 may photograph a patient so as to generate a PET image, and may use a single computer tomography (CT) image and a magnetic resonance (MR) image to perform attenuation correction with respect to the PET image. In this example, the CT image may be generated by photographing the patient using a separate CT device.

Also, the MR image may be generated by photographing the patient using an MR imaging device, separately, or may be generated by a PET-MR device corresponding to a PET device coupled with an MR device. That is, the PET device that photographs and generates a PET image may be utilized as a hybrid-type PET device that photographs and generates a PET image and an MR image, and as another hybrid-type PET device that photographs and generates a PET image, an MR image, and a CT image.

The image obtaining unit 110 may classify MR images and PET images based on a breathing state of the patient so as to obtain n 3D MR images and n 3D PET images. In this example, the PET images and the MR images may be generated by a photographing module (not illustrated) equipped with the PET device. The n 3D MR images and the n 3D PET images generated by the image obtaining unit 110 may be high-definition images. Also, the single CT image may also be a high definition image.

The image obtaining unit 110 may measure a volume of air associated with the breathing of the patient while an MR image and a PET image of the patient are photographed, and may classify a breathing state of the patient based on a volume of air. Also, the MR images and the PET images may be classified into n images based on a breathing state of the patient and thus, the n 3D MR images and the n 3D PET images may be obtained.

Also, the image obtaining unit 110 may classify a breathing state of the patient based on the movement of a mark by putting the mark on an abdomen or a thorax of the patient before the patient is photographed and thus, the n 3D MR images and the n 3D PET images may be obtained. In addition, the image obtaining unit 110 may record a time of photographing, and may classify a breathing state of the patient based on a corresponding time of photographing and thus, the n 3D MR images and the n 3D PET images may be obtained.

The attenuation correction map generating unit 120 may generate n attenuation correction maps with respect to the n 3D MR images using the single CT image, obtained in advance, associated with the patient. Accordingly, the attenuation correction map generating unit 120 may include a parameter computing unit 121 and a CT attenuation correction map generating unit 122.

The parameter computing unit 121 may designate one of the n 3D MR images as a reference MR image. The parameter computing unit 121 may compute a reference attenuation correction parameter (T₁) by performing non-rigid registration of the CT image and the reference MR image. Also, the parameter computing unit 121 may perform non-rigid registration of the reference MR image and each of remaining MR images among the n 3D MR images so as to compute n−1 attenuation correction parameters (T₂˜Tₙ).

When the parameter computing unit 121 computes T₁ and T₂˜Tₙ, the attenuation correction map generating unit 120 may generate attenuation correction maps with respect to the n 3D MR images by applying the T₁ and each of T₂˜Tₙ with respect to the CT image. Accordingly, the attenuation correction maps may be generated with respect to the n 3D MR images, respectively, and thus, a number of the attenuation correction maps may be n.

The CT attenuation correction map generating unit 122 may generate a CT attenuation correction map from the CT image. In particular, the CT attenuation correction map generating unit 122 may generate, from the CT image, a virtual CT image having attenuation information associated with an energy bandwidth corresponding to the n 3D PET images. Also, the CT attenuation correction map may be generated by applying a transform function to the virtual CT image. Here, the CT attenuation correction map may be attenuation coefficient information of the virtual CT image having an energy bandwidth corresponding to a PET image, for example, 511 kilo-electron volts (KeV).

The attenuation correcting unit 130 may perform attenuation correction with respect to the n 3D PET images using the attenuation correction maps generated by the attenuation correction map generating unit 120. In particular, the attenuation correcting unit 130 may apply, based on a breathing state, the attenuation correction maps to corresponding 3D PET images, respectively, so as to perform attenuation correction with respect to the n 3D PET images. As a result of the attenuation correction, n attenuation-corrected 3D PET images may be generated.

The image generating unit 140 may generate a single PET image by combining the n attenuation-corrected 3D PET images. In particular, the image generating unit 140 may perform non-rigid registration of the n attenuation-corrected 3D PET images, jointly, and may generate the single PET image by combining the n non-rigid registration-performed 3D PET images.

According to the PET device of FIG. 1, attenuation correction with respect to the PET image is performed using the single CT image and the MR image and thus, there is no need for photographing a plurality of CT images. Accordingly, an amount of radiation ray irradiated to the patient may be reduced.

Also, the PET device of FIG. 1 may generate the attenuation correction maps using the single CT image and the n 3D MR images, which are high-definition images, and may perform attenuation correction with respect to the n 3D PET images using the attenuation correction maps and thus, movement, associated with the breathing of the patient, included in the PET image may be accurately corrected.

When it is assumed that the PET device performs attenuation correction with respect to the n 3D PET images using the single CT image without using n MR images, the PET device may utilize a single CT image having a breathing state that is the same as a reference 3D PET image among the n 3D PET images classified based on a breathing state. That is, attenuation correction that generates a reference attenuation correction map by performing non-rigid registration of the reference 3D PET image and the single CT image, that performs non-rigid registration of the n 3D PET images, and that applies the reference attenuation correction map, may need to be performed. The attenuation correction may include a non-rigid registration using n 3D PET images to which attenuation correction is not performed and thus, a performance in correcting a movement associated with the breathing of the patient may be low.

A performance in the non-rigid registration may be improved in proportion to a quality of an image. Accordingly, when non-rigid registration of the n 3D PET images including noise and distortion is performed without attenuation correction, a performance in correcting a movement may be affected. Accordingly, the PET device may perform attenuation correction with respect to the n 3D PET images using the single CT image and the n 3D MR images, which are high-definition images, and may perform non-rigid registration of the n attenuation-corrected 3D PET images and thus, may more accurately correct a movement associated with a breathing state of the patient.

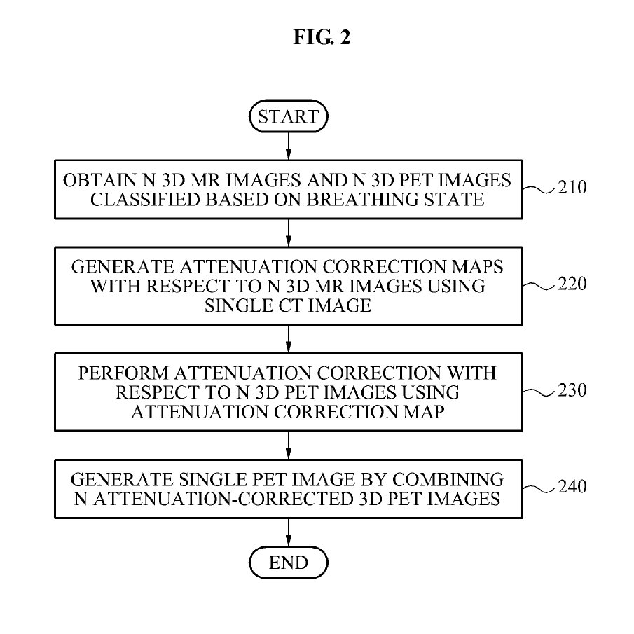

FIG. 2 illustrates a PET image attenuation correcting method according to an embodiment of the present invention. Referring to FIG. 2, a PET device may obtain n 3D PET images and n 3D MR images classified based on a breathing state of an examined patient in operation 210. In this example, the breathing state of the patient may be classified based on a volume of air during the photographing, movement of a mark put on an abdomen or a thorax of the patient, and a time of the photographing.

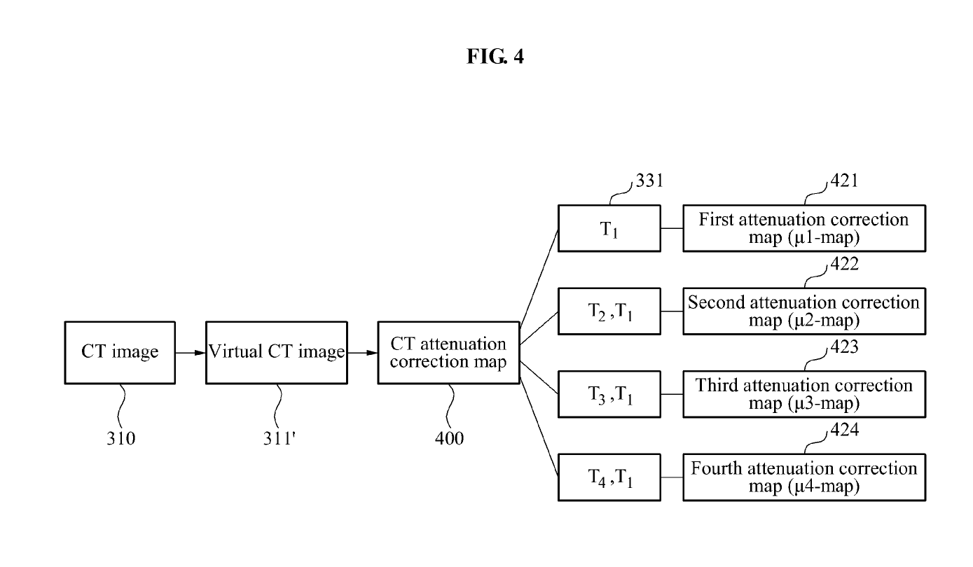

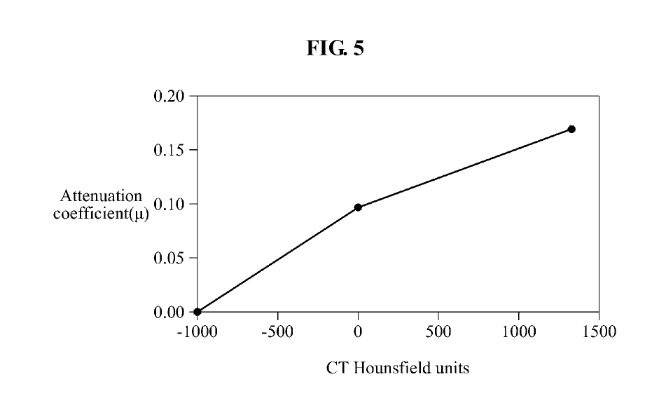

Subsequently, the PET device may generate attenuation correction maps with respect to the n 3D MR images using a single CT image, obtained in advance, associated with the patient in operation 220. In particular, the PET device may compute a reference attenuation correction parameter (T₁) and n−1 attenuation correction parameters (T₂ through Tₙ). for example, the attenuation correction maps with respect to the n 3D MR images may be generated by applying, to a CT attenuation correction map, T₁ and each of T₂ through Tₙ. In this example, the CT attenuation correction map may be generated from the CT image, which will be described with reference to FIGS. 4 and 5.

Subsequently, the PET device may perform attenuation correction with respect to the n 3D PET images using the generated attenuation correction maps in operation 230. The PET device may generate a single PET image by combining the n attenuation-corrected 3D PET images in operation 240. Accordingly, the PET image attenuation correction may be performed using the CT image and an MR image and thus, an amount of radiation irradiated to the patient may be reduced.

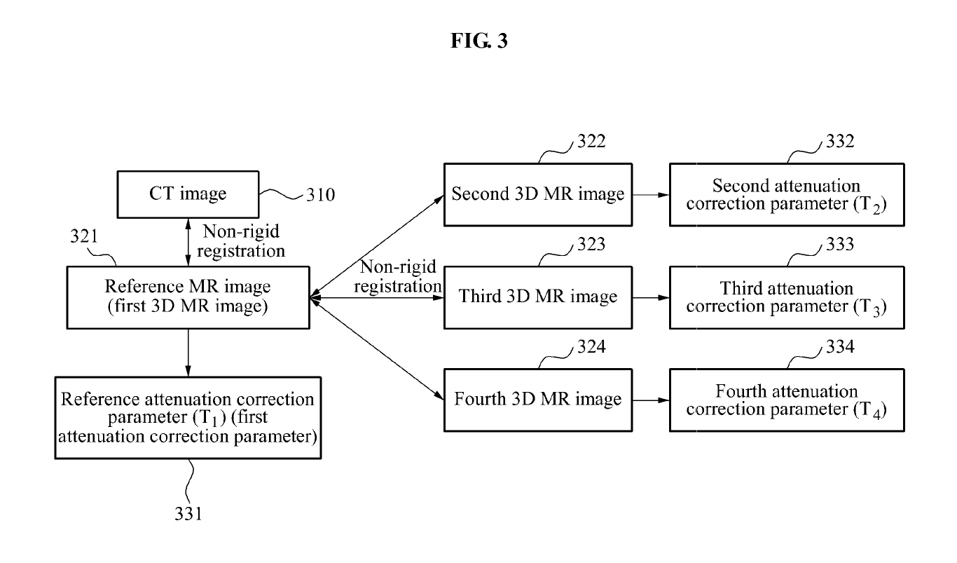

FIG. 3 illustrates an attenuation correction parameter calculating method according to an embodiment of the present invention. Referring to FIG. 3, a PET device may compute first through fourth attenuation correction parameters 331, 332, 333, and 334 using a CT image 310 and first through fourth 3D MR images 321, 322, 323, and 324.

The PET device may compute a reference attenuation correction parameter (T₁) by performing non-rigid registration of the CT image 310 and a reference MR image. In this example, the first 3D MR image 321 may be designated by the PET device as the reference MR image. T₁, computed from the first 3D MR image 321 corresponding to the reference MR 321, may be referred to as the first attenuation correction parameter 331.

First, the PET device may compute T₁ by performing non-rigid registration of the CT image 310 and the reference MR image 321. The PET device may perform non-rigid registration of the reference MR image 321 and each of the second through the fourth 3D MR images 322, 323, and 324 so as to compute second through fourth attenuation correction parameters (T₂ through T₄). That is, the PET device may perform non-rigid registration of the first 3D MR image 321 and the second 3D MR image 322, may perform non-rigid registration of the first 3D MR image 321 and the third 3D MR image 323, and may perform non-rigid registration of the first 3D MR image 321 and the fourth 3D MR image 324 and thus, the PET device may perform the non-rigid registration three times in total.

The non-rigid registration may be used for modeling a local modification between the first 3D MR image 321 and each of the second through fourth 3D MR images 322, 323, and 324, and may be performed based on a B-spline based free form deformation (FFD) model. In particular, the PET device may measure a similarity between the first 3D MR image 321, which is the reference MR image, and each of the second through fourth 3D MR images 322, 323, and 324, and may perform non-rigid registration based on a result of the measurement. In this example, the PET device may use a normalized mutual information function or a cross-correlation function, as a similarity measurement function. The PET device may apply a multi-resolution scheme to optimally perform non-rigid registration based on a result of the measurement of the similarity.

T₁ through T₄ may be results of the non-rigid registrations, and may be parameters indicating movement information associated with a patient when the CT image or the MR image is photographed. In particular, T₁ may indicate movement information associated with the patient when the CT image is photographed and the MR image are photographed. Also, T₂ may be associated with the first 3D MR image 321 and the second MR image 322, T₃ may be associated with the first 3D MR image 321 and the third MR image 323, and T₄ may be associated with the first MR image 321 and the fourth 3D MR image 324, which are parameters indicating movement information associated with the patient for each breathing state.

Although a process of computing T₁ through T₄ using the four 3D MR images 321 through 324 has been described, a number of classified MR images may be greater than four depending on breathing states.

FIG. 4 illustrates a method of generating an attenuation correction maps with respect to a 3D MR image according to an embodiment of the present invention. Referring to FIG. 4, a PET device may generate an attenuation correction map with respect to a 3D MR image using a reference attenuation correction parameter (T₁) and second through fourth attenuation correction parameters (T₂ through T₄) computed as described with reference to FIG. 3.

The PET device may generate a virtual CT image 311 based on the CT image 310, and may generate a CT attenuation correction map 400 using the virtual CT image 311. In particular, the CT attenuation correction map 400 may be generated from the CT image 310, and may be attenuation correction information associated with the virtual CT image 311 having an energy bandwidth corresponding to the PET image.

In general, the CT image 310 may have an energy bandwidth of 80 through 120 kiloelectron volts (KeV). Accordingly, to perform attenuation correction of the PET image using the CT image 310, the PET device may generate the virtual CT image 311 including attenuation information corresponding to an energy bandwidth of 511 KeV. As illustrated in FIG. 5, attenuation coefficient information associated with the virtual CT image 311, that is, a CT attenuation correction map 400, may be generated based on a transform function graph. The transform function graph illustrated in FIG. 5 may show attenuation coefficient information (μ) for each value of a Hounsfield unit scale of the virtual CT image 311.

When the CT attenuation correction map 400 is generated based on the transform function graph 500 of FIG. 5, the PET device may generate first through fourth attenuation correction maps 421, 422, 423, and 424, by applying, to the CT attenuation correction map 400, T₁ and each of T₂ through T₄.

The PET device may generate the first attenuation correction map 421 by applying T₁ to the CT attenuation correction map 400. In particular, the PET device may compute an attenuation correction coefficient by performing curvilinear integral with respect to the CT attenuation correction map 400 using Equation 1, and may generate the first attenuation correction map 421 by multiplying the attenuation correction coefficient and T₁.

Here, the first attenuation correction map 421 may be an attenuation correction map with respect to the first 3D MR image 321.

∫_{xεS}μ(x)dx

In Equation 1, μ denotes a CT attenuation correction map, that is, attenuation correction information, x denotes a location of a pixel in the virtual CT image 311, and S denotes a straight line corresponding to a point in the CT image 311.

As described in the foregoing, the second attenuation correction map 422 with respect to the second 3D MR image 322 may be generated by applying T₁ and T₂ to the CT attenuation correction map 313. The third attenuation correction map 423 with respect to the third 3D MR image 323 may be generated by applying T₁ and T₃ to the CT attenuation correction map 313. Also, the fourth attenuation correction map 424 with respect to the third MR image 323 may be generated by applying T₁ and T₄ to the CT attenuation correction map 400.

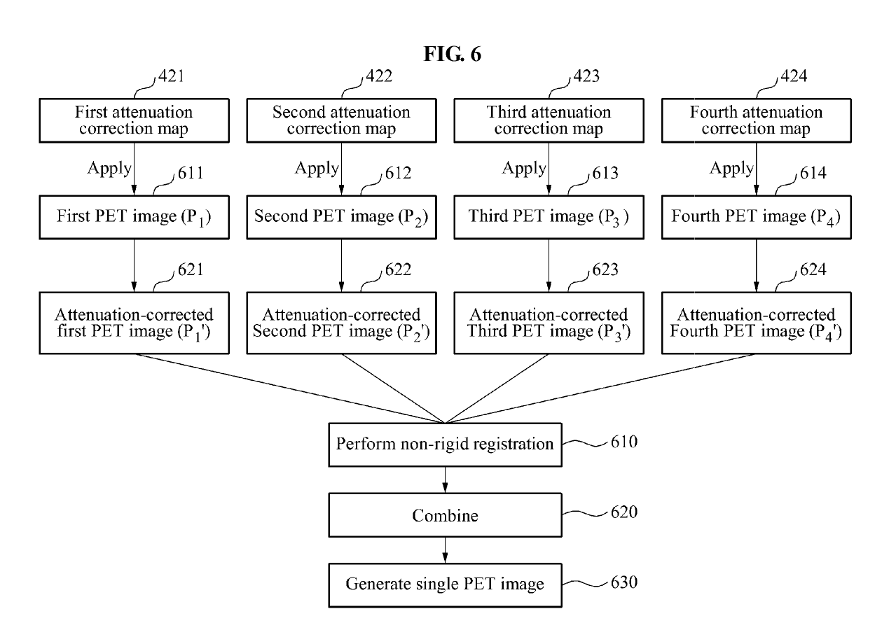

FIG. 6 illustrates a PET image attenuation correcting method using an attenuation correction map according to an embodiment of the present invention. Referring to FIG. 6, a PET device may perform attenuation correction with respect to a PET image using an attenuation correction map with respect to a 3D MR image generated as described in the foregoing with reference to FIG. 4.

The PET device may apply attenuation correction maps with respect to n 3D MR images, to n 3D PET images corresponding to breathing states of the n 3D MR images, respectively.

According to an embodiment of the present invention, the first 3D MR image 321 and a first PET image 611 has the same breathing state, the second 3D MR image 322 and a second PET image 612 has the same breathing state, the third 3D MR image 323 and a third PET image 613 has the same breathing state, and the fourth 3D MR image 324 and a fourth PET image 614 has the same breathing state.

The PET device may generate a first PET image (P₁′) 621 of which attenuation is corrected, by applying, to the first PET image (P₁) 611, the first attenuation correction map 421 with respect to the first 3D MR image 321. In particular, the PET device may compute an attenuation correction coefficient by performing a curvilinear integral with respect to the first attenuation correction map 421, and multiplying the attenuation correction coefficient and P₁ 611 so as to generate P₁′ 621. In the same manner, a second PET image (P₂′) 622, of which attenuation is corrected, may be generated by applying, to the second PET image (P₂) 612, the second attenuation correction map 422 with respect to the second 3D MR image 322. Also, a third PET image (P₃′) 614, of which attenuation is corrected, may be generated by applying, to the third PET image (P₃) 613, the third attenuation correction map 423 with respect to the third 3D MR image 323. A fourth PET image (P₄′) 624, of which attenuation is corrected, may be generated by applying, to the fourth PET image (P₄) 614, the fourth attenuation correction map 424 with respect to the fourth 3D MR image 324. In this manner, the PET device may perform attenuation correction with respect to P₁ through P₄.

When the attenuation of P₁ through P₄ is corrected, the PET device may perform non-rigid registration with respect to P₁ through P₄ jointly in operation 610, may combine P₁′ through P₄′ in operation 620, and may generate a single PET image of which attenuation is corrected in operation 630. In this example, each PET image may be transformed into an image having a single breathing state by performing the non-rigid registration with respect to P₁ through P₄ of which attenuation is corrected.

The PET device may perform attenuation correction with respect to the PET image using a single CT image and thus, a plurality of CT images may not need to be photographed. Accordingly, an amount of radiation irradiated to the patient may be reduced.

Also, attenuation correction with respect to the PET image may be performed using a CT image and 3D MR images, which are high-definition images and thus, movement associated with a breathing state of the patient may be accurately corrected.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of correcting attenuation of a positron emission tomography (PET) image, the method comprising:
obtaining n three-dimensional (3D) magnetic resonance (MR) images and n 3D PET images classified based on a breathing state of an examined patient;
generating attenuation correction maps with respect to the n 3D MR images using a single computed tomography (CT) image, obtained in advance, associated with the patient;
correcting attenuation of the n 3D PET images based on the generated attenuation correction maps; and
generating a single PET image by combining the n attenuation-corrected 3D PET images.

2. The method of claim 1, wherein the generating of the attenuation correction maps comprises:
generating a CT attenuation correction map from the CT image;
designating one of the n 3D MR images as a reference MR image;
computing a reference attenuation correction parameter by performing non-rigid registration of the CT image and the reference MR image;
computing n−1 attenuation correction parameters by non-rigid registration of the reference MR image and each of remaining MR images among the n 3D MR image; and
generating the attenuation correction maps with respect to the n 3D MR images by applying, to the CT attenuation correction map, the reference attenuation correction parameter and n−1 attenuation correction parameters.

3. The method of claim 2, wherein the generating of the CT attenuation correction map comprises:
generating, from the CT image, a virtual CT image having attenuation information associated with an energy bandwidth corresponding to the n 3D PET images; and
generating the CT attenuation correction map by applying a transform function to the virtual CT image.

4. The method of claim 1, wherein the correcting corrects the attenuation by applying, based on the breathing state, the attenuation correction maps with respect to the n 3D MR images to the n 3D PET images, respectively, and generates n attenuation-corrected 3D PET images.

5. The method of claim 1, wherein the generating of the single PET image comprises:
performing non-rigid registration of the n attenuation-corrected 3D PET images, jointly; and
generating the single PET image by combining the n non-rigid registration-performed 3E PET images.

6. The method of claim 1, wherein the obtaining comprises:
photographing MR images and PET images of the patient;
measuring a volume of air associated with breathing of the patient during the photographing; and
obtaining the n 3D MR images and the 3D PET images by classifying the MR images and the PET images into n images based on the volume of air.

7. A positron emission tomography (PET) device, the device comprising:
an image obtaining unit to classify magnetic resonance (MR) images and PET images based on a breathing state of an examined patient so as to obtain n three-dimensional (3D) MR images and n 3D PET images;
an attenuation correction map generating unit to generate attenuation correction maps with respect to the n 3D MR images, using a single CT image, obtained in advance, associated with the patient;
an attenuation correcting unit to correct attenuation of the n 3D PET images, using the generated attenuation correcting maps; and
an image generating unit to generate a single PET image by combining the n attenuation-corrected 3D PET images.

8. The PET device of claim 7, wherein the attenuation correcting map generating unit further comprises:
a parameter computing unit to designate one of the n 3D MR images as a reference MR image, to compute a reference attenuation correction parameter by performing non-rigid registration of the CT image and the reference MR image, and to compute n−1 attenuation correction parameters by performing non-rigid registration of the reference MR image and each of remaining MR images among the n 3D MR images;
a CT attenuation correction map generating unit to generate a CT attenuation correction map from the CT image,
wherein the attenuation correction maps with respect to the n 3D MR images are generated by applying the reference attenuation correction parameter and each of the n−1 attenuation correction parameters to the CT attenuation correction map.

9. The PET device of claim 8, wherein the CT attenuation correction map generating unit generates, from the CT image, a virtual CT image having attenuation information associated with an energy bandwidth corresponding to the n 3D PET images, and generates the CT attenuation correction map by applying a transform function to the virtual CT image.

10. The PET device of claim 7, wherein the attenuation correcting unit corrects the attenuation by applying, based on the breathing state, the attenuation correction maps with respect to the n 3D MR images to the n 3D PET images, respectively, and generates n attenuation-corrected 3D PET images.

11. The PET device of claim 7, wherein the image generating unit generates the single PET image by jointly performing non-rigid registration of the n attenuation-corrected 3D PET images, and combines the n non-rigid registration performed-3D PET images.

12. The PET device of claim 7, wherein the image obtaining unit measures a volume of air associated with breathing of the patient while an MR image and a PET image are photographed with respect to the patient, and obtains n 3D MR images and n 3D PET images by classifying, based on a volume of air, M images and PET images into n images.
